(19) United States
(12) Patent Application Publication
(10) Pub. No.: US 2008/0018599 A1
(43) Pub. Date: Jan. 24, 2008

(54) Space positioning and directing input system and processing method therefor

(75) Inventor: Tien-Chien Chang, Hsin-Chu City (TW)

Correspondence Address: BIRCH STEWART KOLASCH & BIRCH, PO BOX 747, FALLS CHURCH, VA, 22040-0747, US

(73) Assignee: UPI SEMICONDUCTOR Corp.

(21) Appl. No.: 11/822,834

(22) Filed: Jul. 10, 2007

Related U.S. Application Data
(60) Provisional application No. 60/832,601, filed on Jul. 24, 2006.

(51) Int. Cl. G06F 3/033

(52) U.S. Cl. 345/158

(57) ABSTRACT

A space positioning and directing input system is disclosed. A light source is installed on a space positioning and directing input device to emit the light. First and second image detection devices receive the light and generate first and second imaging pictures. An operation device calculates first and second image positions of the light source based on imaging information of the first and second image pictures and calculates three-dimensional space coordinates of the first and second imaging positions.

### BACKGROUND OF THE INVENTION

1. Field of the Invention

The invention relates to an input device, and more particularly to a space positioning and directing input system, applied a data operation processing based space or plane positioning system comprising a human machine interface.

2. Description of the Related Art

Current positioning or directional devices (such as a mouse, a joystick, and so forth) are not very convenient or easy to utilize, disregarding ergonomical design and application for users. Thus, the invention provides a space positioning and directing input device, provided at relatively lower costs and corresponding to ergonomic requirements and is effortless and more convenient to utilize.

### BRIEF SUMMARY OF THE INVENTION

The invention provides space positioning and directing input systems. An exemplary embodiment of a space positioning and directing input system comprises at least one space positioning and directing input device and a display device. The space positioning and directing input device comprises a light source to emit light. The display device further comprises a first image sensor, a second image sensor, and an operation device. The first image sensor receives the light to generate a first imaging picture. The second image sensor receives the light to generate a second imaging picture. The operation device calculates a first imaging position and a second imaging position corresponding to the light source according to imaging information of the first and second imaging pictures and calculates 3D space coordinates corresponding to the first and second imaging positions.

Another embodiment of a space positioning and directing input system comprises at least one space positioning and directing input device and a display device. The space positioning and directing input device comprises a reflection device to reflect light; and an operation device. The display device further comprises a light source, a first image sensor, a second image sensor, and an operation device. The light source emits light. The first image sensor receives the light of the reflection device to generate a first imaging picture. The second image sensor receives the light of the reflection device to generate a second imaging picture. The operation device calculates a first imaging position and a second imaging position corresponding to the reflection device according to imaging information of the first and second imaging pictures and calculates 3D space coordinates corresponding to the first and second imaging positions.

Another embodiment of a space positioning and directing input system comprises a first space positioning and directing input device, a second space positioning and directing input device, and a display device. The first space positioning and directing input device comprises a light source to emit a first light. The second space positioning and directing input device comprises a light source to emit a second light. The display device further comprises a first image sensor, a second image sensor, and an operation device. The first image sensor receives the first light to generate a first imaging picture. The second image sensor receives the second light to generate a second imaging picture. The operation device calculates the first and third imaging positions corresponding to the first light source and second and fourth imaging positions corresponding to the second light source according to imaging information of the first and second imaging pictures and calculates 3D space coordinates corresponding to the first, second, third, and fourth imaging positions.

Another embodiment of a space positioning and directing input system comprises a first space positioning and directing input device, a second space positioning and directing input device, and a display device. The first space positioning and directing input device comprises a first reflection device reflecting light to generate a first reflective light. The second space positioning and directing input device comprises a second reflection device reflecting light to generate a second reflective light. The display device further comprises a light source, a first image sensor, a second image sensor, and an operation device. The light source emits light. The first image sensor receives the first and second reflective lights to generate a first imaging picture. The second image sensor receives the first and second reflective lights to generate a second imaging picture. The operation device calculates the first and third imaging positions corresponding to the first reflection device and the second and fourth imaging positions corresponding to the second reflection device according to imaging information of the first and second imaging pictures and calculates 3D space coordinates corresponding to the first, second, third, and fourth imaging positions.

Another embodiment of a space positioning and directing input system comprises at least one space positioning and directing input device installed on a plane and a display device. The space positioning and directing input device comprises a light source emitting light. The display device further comprises an image sensor and an operation device. The image sensor receives the light to generate an imaging picture. The operation device calculates a first imaging position corresponding to the light source of the space positioning and directing input device according to imaging information of the imaging picture and calculates a second imaging position on the display device according to the first imaging position.

Another embodiment of a space positioning and directing input system comprises at least one space positioning and directing input device installed on a plane and a display device. The space positioning and directing input device comprises a reflection device reflecting light to generate a reflective light. The display device further comprises a light source, an image sensor, and an operation device. The light source emits light. The image sensor receives the reflective light to generate an imaging picture. The operation device calculates a first imaging position corresponding to the reflection device according to imaging information of the imaging picture and calculates a second imaging position on the display device according to the first imaging position.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a first embodiment of a space positioning and directing input system;

FIG. 2 is a schematic view of imaging pictures and positions of the first and second embodiments;

FIG. 3 is a schematic view of a second embodiment of a space positioning and directing input system;

FIG. 4 is a schematic view of a third embodiment of a space positioning and directing input system;

FIG. 5 is a schematic view of imaging pictures and positions of the third and fourth embodiments;

FIG. 6 is a schematic view of a fourth embodiment of a space positioning and directing input system;

FIG. 7 is a schematic view of a fifth embodiment of a space positioning and directing input system;

FIG. 8 is a schematic view of imaging pictures and positions of the fifth and sixth embodiments;

FIG. 9 is a schematic view of a sixth embodiment of a space positioning and directing input system;

FIG. 10 is a schematic view of a seventh embodiment of a space positioning and directing input system;

FIG. 11 is a schematic view of imaging pictures and positions of the seventh and eighth embodiments;

FIG. 12 is a schematic view of an eighth embodiment of a space positioning and directing input system;

FIG. 13 is a schematic view of a ninth embodiment of a space positioning and directing input system;

FIG. 14 is a schematic view of a tenth embodiment of a space positioning and directing input system;

FIG. 15 is a schematic view of an eleventh embodiment of a space positioning and directing input system;

FIG. 16 is a schematic view of a twelfth embodiment of a space positioning and directing input system;

FIG. 17 is a schematic view of an embodiment of an object correspondence;

FIGS. 18 and 19 are schematic views of an embodiment of a two-dimensional (2D) grid positioning;

FIG. 20 is a flowchart of a processing method for the first embodiment of the space positioning and directing input system;

FIG. 21 is a flowchart of a processing method for the second embodiment of the space positioning and directing input system;

FIG. 22 is a flowchart of a processing method for the third embodiment of the space positioning and directing input system;

FIG. 23 is a flowchart of a processing method for the fourth embodiment of the space positioning and directing input system;

FIG. 24 is a flowchart of another processing method for the first embodiment of the space positioning and directing input system; and

FIG. 25 is a flowchart of another processing method for the first embodiment of the space positioning and directing input system.

### DETAILED DESCRIPTION OF THE INVENTION

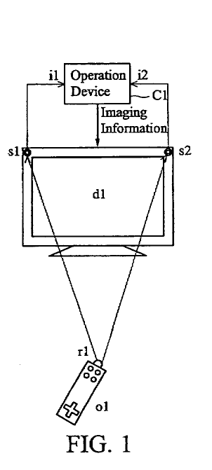

Several exemplary embodiments of the invention are described with reference to FIGS. 1 through 25, which generally relate to space positioning and directing input processing. It is to be understood that the following disclosure provides various different embodiments as examples for implementing different features of the invention. Specific examples of components and arrangements are described in the following to simplify the present disclosure. These are merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a space positioning and directing input system and processing method therefor.

An embodiment of a space positioning and directing input system is a system comprising a human machine interface, and a space positioning and directing input device. The space positioning and directing input system receives light (the light from an active light source or passively reflected light) emitted by a positioned object (i.e. a space positioning and directing input device) using a sensor, processes detected data by the sensor using an operation device to reversely calculate three-dimensional (3D) or two-dimensional (2D) projection coordinates, and generates other information, such as velocity, acceleration, depression operations, and so forth, according to the calculated coordinates or detection information, such as from moving a positioned object or depressing a preset button.

The following illustrates embodiments of a space positioning and directing input system and processing method therefor.

An embodiment of employed components are first described and symbolized respectively.

Imaging display devices (symbolized by d1, d2 . . . ) indicate computer monitors, personal digital assistants (PDA), cellular phones, TV monitors, and so forth.

Image sensors (symbolized by s1, s2 . . . ) indicate image input devices comprising charge coupled devices (CCD) sensors, complementary metal-oxide semiconductor (CMOS), and so forth.

Imaging pictures (symbolized by i1, i2 . . . ) indicate pictures detected by image sensors (s1, s2 . . . ).

Imaging positions of objects on a monitor (symbolized by p1, p2 . . . ) indicate shape centers of gravity, geometric centers of gravity, or 2D coordinates of a point representing an object that is imaged on an imaging display device.

Light sources (symbolized by l1, l2 . . . ) indicate visible light, infrared (IR) rays, ultraviolet (UV) rays, and so forth.

Positioned objects (symbolized by o1, o2 . . . ) indicate space positioning and directing input devices. It is noted that a positioned object represents a space positioning and directing input device, which will not be further explained.

Reflection devices (symbolized by r1, r2 . . . ) indicate reflective structures and special shapes or textures composed of reflective structures.

FIG. 1 is a schematic view of a first embodiment of a space positioning and directing input system.

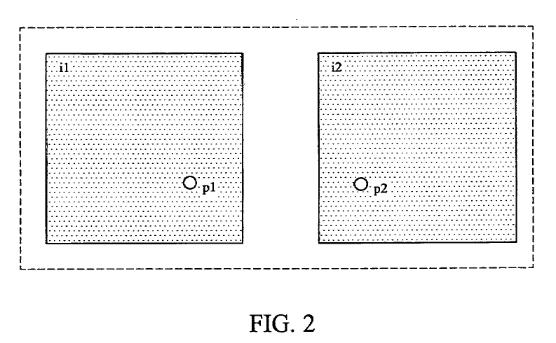

Imaging display device d1 (a monitor, for example) comprises image sensors s1 and s2 and an operations device c1. Positioned object o1 (a joystick of a TV game, for example) comprises light source l1. Light source l1 of positioned object o1 first emits light while image sensors s1 and s2 receives the light to generate two imaging pictures i1 and i2, as shown in FIG. 2. Operations device c1, using an object extraction method, calculates imaging positions p1 and p2 on imaging pictures i1 and i2 corresponding to light source l1, via image sensors s1 and s2, according to imaging information of imaging pictures i1 and i2, and calculates 3D space coordinates of an imaging position at a time point corresponding to light source l1 according to imaging positions p1 and p2 using a triangulation method.

As described, 3D space coordinates of imaging positions at different time points corresponding to light source l1 can be calculated and other imaging information (such as velocity, acceleration, depression operations, and so forth) can thus be generated by depression operation recognition.

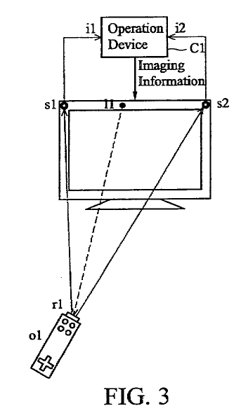

FIG. 3 is a schematic view of a second embodiment of a space positioning and directing input system.

Imaging display device d1 (a monitor, for example) comprises light source l1, image sensors s1 and s2, and operation device c1. Positioned object o1 (a joystick of a TV game, for example) comprises reflection device r1. Light source l1 first emits light, reflected by reflection device r1, while image sensors s1 and s2 receives the reflective light to generate imaging pictures i1 and i2, as shown in FIG. 2. Next, the process of calculating 3D space coordinates of imaging positions p1 and p2 on imaging pictures i1 and i2 corresponding to the reflective light from reflection device r1 is identical to that described in the first embodiment, as such will not be further described.

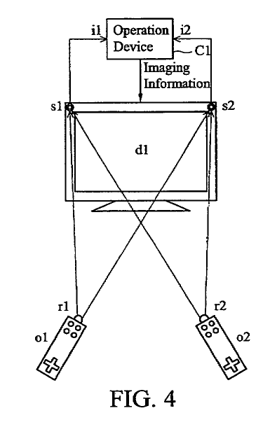

FIG. 4 is a schematic view of a third embodiment of a space positioning and directing input system.

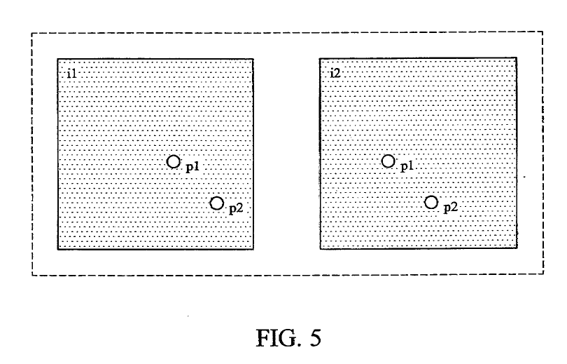

Imaging display device d1 (a monitor, for example) comprises image sensors s1 and s2 and operation device c1. Positioned object o1 (a joystick of a TV game, for example) comprises light source l1. Positioned object o2 (a joystick of a TV game, for example) comprises light source l2. Light sources l1 and l2 emits light while image sensors s1 and s2 receive the light to generate imaging pictures i1 and i2, as shown in FIG. 5. Operation device c1, using an object extraction method, calculates imaging positions on imaging pictures i1 and i2 corresponding to light sources l1 and l2, via image sensors s1 and s2, according to imaging information of imaging pictures i1 and i2. The imaging positions comprise p1(i1), p2(i1), p1(i2), and p2(i2).

Next, operation device c1 corresponds imaging positions p1(i1), p2(i1) and p1(i2), and p2(i2) to imaging positions p1(l1), p2(l1), p1(l2), and p2(l2), respectively using a correspondence method. When imaging pictures i1 or i2 corresponding to light source l1 and l2 overlaps, operation device cl calculates imaging positions p1(l1), p2(l1), p1(l2), and p2(l2) using an Epipolar method and calculates 3D space coordinates of an imaging position at a time point corresponding to light sources l1 and l2 using a triangulation method.

As described, 3D space coordinates of imaging positions at different time points corresponding to light sources l1 and l2 can be calculated and other imaging information (such as velocity, acceleration, depression operations, and so forth) can thus be generated by depression operation recognition or a labeling method.

It is noted that 3D space coordinates of imaging positions at different time points corresponding to light sources (l1, l2, . . . , ln) for multiple positioned objects (o1, o2, . . . , on) can also be obtained using the described method, thereby obtaining other imaging information, such as velocity, acceleration, depression operations, and so forth.

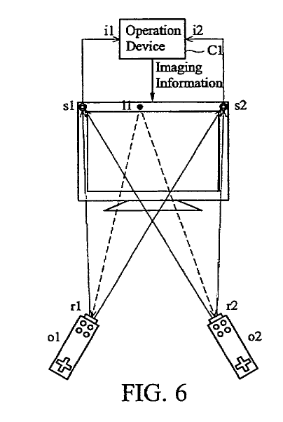

FIG. 6 is a schematic view of a fourth embodiment of a space positioning and directing input system.

Imaging display device d1 (a monitor, for example) comprises light source l1, image sensors s1 and s2, and operation device c1. Positioned object o1 (a joystick of a TV game) comprises a reflection device r1 while positioned object o2 (a joystick of a TV game) comprises a reflection device r2. Light source l1 emits light while image sensors s1 and s2 receive the reflective light from reflection devices r1 and r2 to generate imaging pictures i1 and i2, as shown in FIG. 5. Next, the process of calculation of 3D space coordinates of imaging positions p1(l1), p2(l1), and p1(l2), and p2(l2) corresponding to the reflective light from reflection devices r1 and r2, respectively, is identical to that described in the third embodiment, as such will not be further described.

As described, 3D space coordinates of imaging positions at different time points corresponding to reflection devices (r1, r2, . . . , rn) for multiple positioned objects (o1, o2, . . . , on) can also be obtained using the described method, thereby obtaining other imaging information, such as velocity, acceleration, depression operations, and so forth.

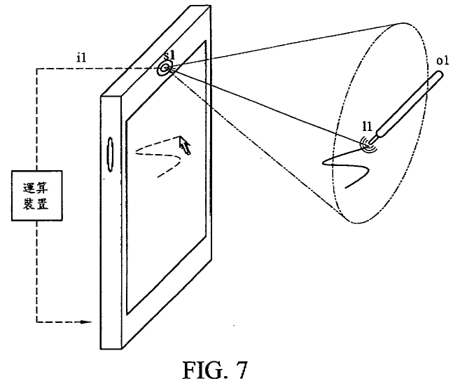

FIG. 7 is a schematic view of a fifth embodiment of a space positioning and directing input system.

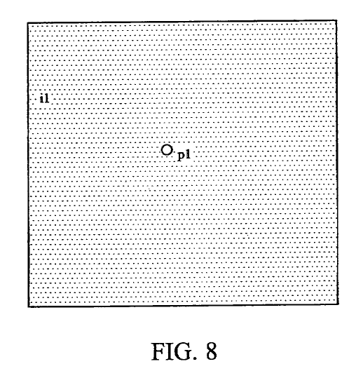

Imaging display device d1 (a monitor, for example) comprises image sensor s1 and operation device c1. Positioned object o1 (a light pen, for example) comprises light source l1. Light source l1 emits light while image sensor s1 receives the light to generate imaging picture i1, as shown in FIG. 8. Operation device c1, using an object extraction method, calculates imaging position p1 on imaging picture i1 corresponding to light source l1, via image sensors s1, according to imaging information of imaging picture i1.

2D coordinates of imaging positions at different time points corresponding to light source l1 can be calculated and other imaging information (such as velocity, acceleration, depression operations, and so forth) can thus be generated by depression operation recognition.

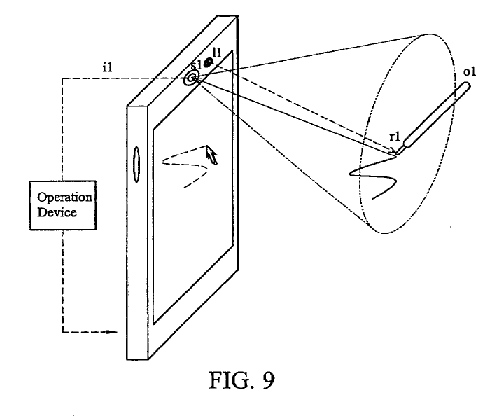

FIG. 9 is a schematic view of a sixth embodiment of a space positioning and directing input system.

Imaging display device d1 (a monitor, for example) comprises light source l1, image sensor s1, and operation device c1. Positioned object o1 (a light pen, for example) comprises reflection device r1. Light source l1 emits light while image sensor s1 receives the reflective light from reflection device r1 to generate imaging picture i1, as shown in FIG. 8. Next, the process of calculation of 2D coordinates of imaging position p1 corresponding to the reflective light from reflection device r1 is identical to that described in the fifth embodiment, as such will not be further described.

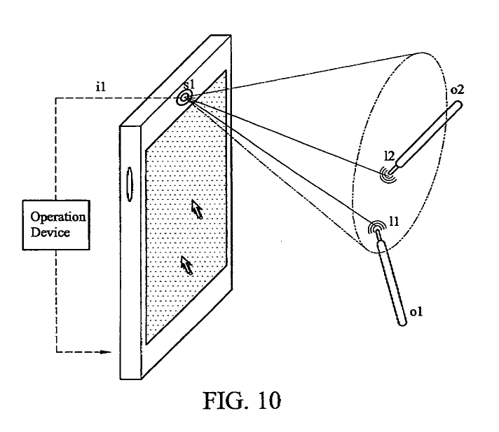

FIG. 10 is a schematic view of a seventh embodiment of a space positioning and directing input system.

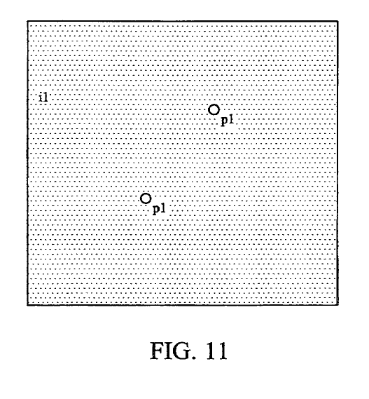

Imaging display device d1 (a monitor, for example) comprises image sensors s1 and operation device c1. Positioned object o1 (a light pen, for example) comprises light source l1. Positioned object o2 (a light pen, for example) comprises light source l2. Light sources l1 and l2 emits light while image sensors s1 and s2 receive the light to generate imaging picture i1, as shown in FIG. 11. Operation device c1, using an object extraction method, calculates imaging positions p1 and p2 on imaging picture i1 corresponding to light sources l1 and l2 according to imaging information of imaging picture i1.

2D coordinates of imaging positions p1 and p2 at different time points can be calculated using a labeling method and other imaging information (such as velocity, acceleration, depression operations, and so forth) can thus be generated by depression operation recognition.

It is noted that 2D coordinates of imaging positions at different time points corresponding to light sources (l1, l2, . . . , ln) for multiple positioned objects (o1, o2, . . . , on) can also be obtained using the described method, thereby obtaining other imaging information, such as velocity, acceleration, depression operations, and so forth.

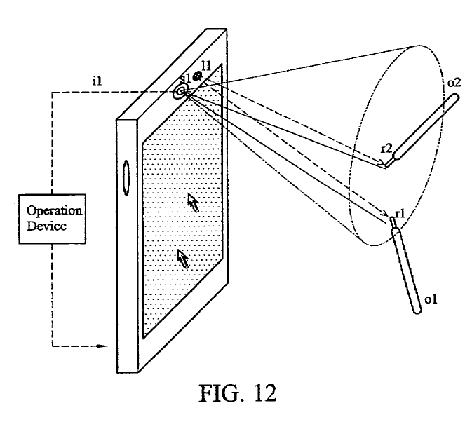

FIG. 12 is a schematic view of an eighth embodiment of a space positioning and directing input system.

Imaging display device d1 (a monitor, for example) comprises light source l1, image sensor s1, and operation device c1. Positioned object o1 (a light pen, for example) comprises reflection device r1. Positioned object o2 (a light pen, for example) comprises reflection device r2. Light source l1 emits light while image sensor s1 receives the reflective light from reflection device r1 to generate imaging picture i1, as shown in FIG. 11. Next, the process of calculation of 2D coordinates of imaging position p1 corresponding to light source l1 r1 is identical to that described in the seventh embodiment, as such will not be further described.

It is noted that 2D coordinates of imaging positions at different time points corresponding to reflective light from reflection devices (r1, r2, . . . , m) for multiple positioned objects (o1, o2, . . . , on) can also be obtained using the described method, thereby obtaining other imaging information, such as velocity, acceleration, depression operations, and so forth.

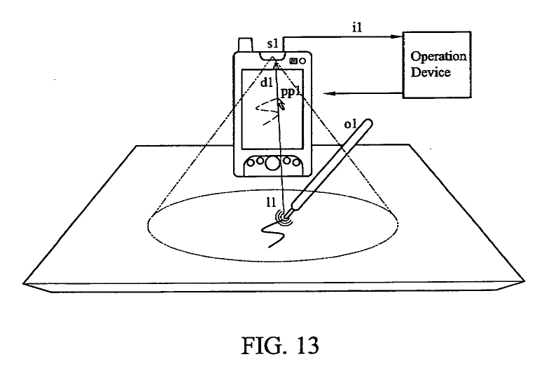

FIG. 13 is a schematic view of a ninth embodiment of a space positioning and directing input system.

Imaging display device d1 (a PDA, for example) comprises image sensor s1 and operation device c1. Positioned object o1 (a light pen, for example) comprises light source l1. Light source l1 installed on a plane emits light while image sensor s1 receives the light to generate imaging picture i1, as shown in FIG. 8. Operation device c1, using an object extraction method, calculates imaging position p1 on imaging pictures i1 corresponding to light source l1, via image sensors s1, according to imaging information of imaging picture i1.

Next, operation device c1 generates a converted imaging position pp1 displayed on display device d1 using a 2D grid positioning method and other imaging information (such as velocity, acceleration, depression operations, and so forth) can thus be generated by depression operation recognition based on the time variation of imaging position pp1.

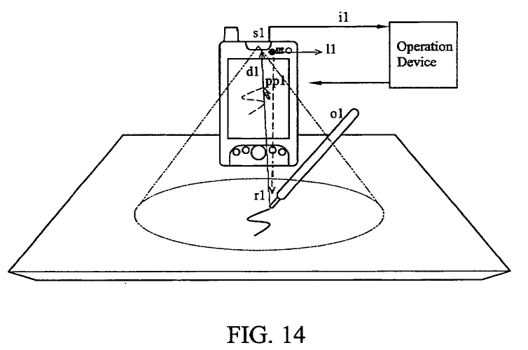

FIG. 14 is a schematic view of a tenth embodiment of a space positioning and directing input system.

Imaging display device d1 (a PDA, for example) comprises light source l1, image sensor s1, and operation device c1. Positioned object o1 (a light pen, for example) comprises reflection device r1. Light source l1 emits light while image sensor s1 receives the reflective light from reflection device r1 installed on a plane to generate imaging picture i1, as shown in FIG. 8. Next, the process of calculating imaging position p1 corresponding to the reflective light from reflection device r1 and obtaining a converted imaging position pp1 displayed on display device d1 using a 2D grid positioning method is identical to that described in the ninth embodiment, as such will not be further described.

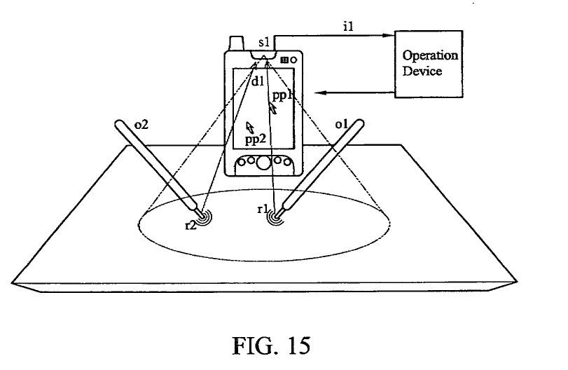

FIG. 15 is a schematic view of an eleventh embodiment of a space positioning and directing input system.

Imaging display device d1 (a PDA, for example) comprises image sensor s1 and operation device c1. Positioned object o1 (a light pen, for example) comprises light source l1. Positioned object o2 (a light pen, for example) comprises light source l2. Light sources l1 and 12 installed on a plane emit light while image sensor s1 receives the light to generate imaging picture i1, as shown in FIG. 11. Operation device c1, using an object extraction method, calculates imaging positions p1 and p2 on imaging pictures i1 corresponding to light source l1, via image sensors s1, according to imaging information of imaging picture i1.

Next, operation device c1 generates converted imaging positions pp1 and pp2 displayed on display device d1 using a 2D grid positioning method. 2D coordinates of imaging positions pp1 and pp2 at different time points can be calculated using a labeling method and other imaging information (such as velocity, acceleration, depression operations, and so forth) can thus be generated by depression operation recognition.

It is noted that imaging positions (p1, p2, . . . , pn) on imaging picture i1 corresponding to light sources (l1, l2, . . . , ln) for multiple positioned objects (o1, o2, . . . , on) can also be calculated using the described method, and 2D coordinates of converted imaging positions (pp1, pp2, . . . , ppn) displayed on display device d1 can be further calculated using a 2D grid positioning method.

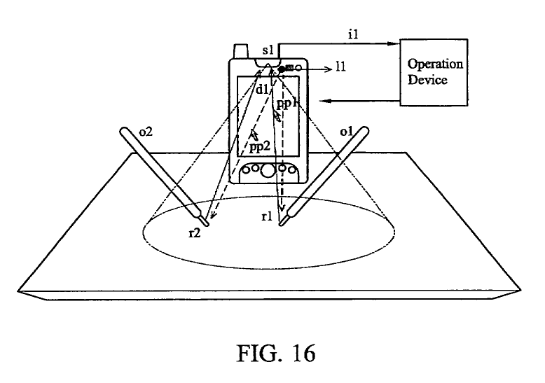

FIG. 16 is a schematic view of a twelfth embodiment of a space positioning and directing input system.

Imaging display device d1 (a PDA, for example) comprises light source l1, image sensor s1, and operation device c1. Positioned object o1 (a light pen, for example) comprises reflection device r1. Positioned object o2 (a light pen, for example) comprises reflection device r2. Light source l1 emits light while image sensor s1 receives the reflective light from reflection devices r1 and r2 to generate imaging picture i1, as shown in FIG. 11.

Next, the process of calculating imaging positions p1 and p2 on imaging picture i1 corresponding to the reflective light from reflection devices r1 and r2 and obtaining converted imaging positions pp1 and pp2 displayed on display device d1 using a 2D grid positioning method is identical to that described in the eleventh embodiment, as such will not be further described.

It is noted that imaging positions (p1, p2, . . . , pn) on imaging picture i1 corresponding to reflection devices (r1, r2, . . . , m) for multiple positioned objects (o1, o2, . . . , on) can also be calculated using the described method, and 2D coordinates of converted imaging positions (pp1, pp2, . . . , ppn) displayed on display device d1 can be further calculated using a 2D grid positioning method.

The following describes the object extraction method, the labeling method, the correspondence method, the triangulation method, the 2D grid positioning method, and the depression operation recognition.

The object extraction provides a thresholding method, also named object and background segmentation method. With respect to IR ray of invisible light, for example, only the object itself (representing an active light source or comprising a light reflection portion) of the input image shines while other areas of the input image represent the background and show a black color. A traced object and the background of such input image can be separated, comprising the following.

An input image is first divided to pixels belonging to an object and that belonging to the background according to a predetermined fixed threshold. The process can be accurately implemented when the threshold is calculated using an Otsu method. Next, pixels belonging to the traced object are connected to form an object using connected component labeling (CCL).

With respect to a nature light source, for example, the traced object can be represented using a specified color or pattern to be discriminated from the background. Suppose the background is a white wall and the traced object shows the red color, the traced object and background can be easily discriminated based on the color. The position and scope of the traced object is located using CCL.

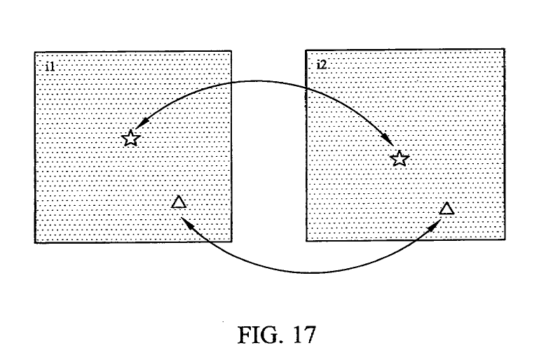

With respect to the correspondence method, objects pictured using two sensors are extracted and correspondence between the objects of the two image frames is obtained. In this embodiment, the correspondence between the objects is obtained according to shapes (as shown in FIG. 17), textures, or the combination with applying Epipolar constraint conditions.

The triangulation method positions target objects in the space using two camera systems. Internal and external parameters for a camera system define K₁, R₁, t₁, K₂, R₂, and t₂ respectively. Rᵢ and tᵢ represent a rotation matrix and a translation vector, respectively.

$$K = [ \begin{matrix}α f & s & {u}_{0} \\ 0 & f & {v}_{0} \\ 0 & 0 & 1\end{matrix} ] ,$$

where s is a skew value, (u₀,v₀) is an optical center, f is a focal length, and α is an aspect ratio.

A point X in the space is projected in the two camera systems, generating points x₁ and x₂, projection relationship thereof is described as:

$${x}_{1} ∼ {K}_{1} [ {R}_{1} \vert {t}_{1} ] X , \\ {x}_{2} ∼ {K}_{2} [ {R}_{2} \vert {t}_{2} ] X , and$$

$${x}_{i} = [ \begin{matrix}{u}_{i} \\ {v}_{i} \\ 1\end{matrix} ] ,$$

where plane coordinates are represented in homogenous coordinates.

Further,

$$X = [ \begin{matrix}x \\ y \\ z \\ 1\end{matrix} ] ,$$

space coordinates are also represented in homogenous coordinates.

As the internal parameters of a camera are known, space coordinates of a point can be calculated according to pictured projection points, i.e. x₁\textcircled{x}K₁[R₁|t₁]X=0 and x₂\textcircled{x}K₂[R₂|t₂]X=0.

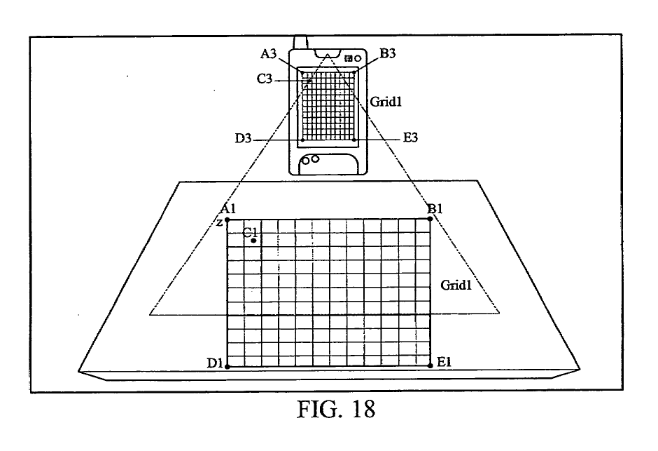

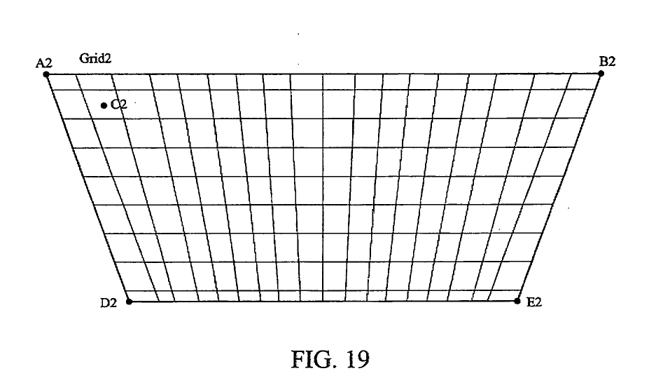

With respect to the 2D grid positioning method, as shown in FIG. 18, image sensor s1 detects the shape of grid 1 as a deformation of grid 2 (as shown in FIG. 19), and the final result is grid 3 displayed on display device d1. Thus, mapping transformation between grids 2 and 3 is first computed and the value of grid point C3 can be calculated from the computed transformation.

Transforming a coordinate position x from grid 2 to grid 3 represents a plane transformation, represented as a formula in the following, in which H represents a 3×3 matrix:

$${x}^{′} ∼ Hx , {x}_{i} = [ \begin{matrix}{u}_{i} \\ {v}_{i} \\ {w}_{i}\end{matrix} ] , {x}_{i}^{′} = [ \begin{matrix}{u}_{i}^{′} \\ {v}_{i}^{′} \\ {w}_{i}^{′}\end{matrix} ] and H [ \begin{matrix}{h}_{11} & {h}_{21} & {h}_{31} \\ {h}_{12} & {h}_{22} & {h}_{32} \\ {h}_{13} & {h}_{23} & {h}_{33}\end{matrix} ] .$$

where x is a point of grid 2 and x′ is the corresponding point of x of grid 3.

The matrix is spread as:

$$\frac{{u}_{i}^{′}}{{w}_{i}^{′}} = \frac{{h}_{11} {u}_{i} + {h}_{12} {v}_{i} + {h}_{13} {w}_{i}}{{h}_{31} {u}_{i} + {h}_{32} {v}_{i} + {h}_{33} {w}_{i}} , and$$

$$\frac{{v}_{i}^{′}}{{w}_{i}^{′}} = \frac{{h}_{21} {u}_{i} + {h}_{22} {v}_{i} + {h}_{23} {w}_{i}}{{h}_{31} {u}_{i} + {h}_{32} {v}_{i} + {h}_{33} {w}_{i}} .$$

The described formulas are further transposed as:

When plane transformation is implemented with wᵢ=1, wᵢ=1 and H₃₃=1, 8 unknown elements are generated. When 4 corresponding points are provided, for instance A2, B2, D2, and E2 in FIG. 19 and A3, B3, D3, and E3 in FIG. 18, two formulas can be generated based on a set of corresponding points. The formulas can be solved using a least square method to obtain a transformation matrix H.

With respect to the depression operation recognition, when fast moving, disappearance, rotation, shape variation, color variation, violent gray level variation, texture variation, object number variation, or the combinations occur to detect objects imaged on imaging pictures i1 and i2, a button depression operation is thus activated. Other kinds of variations can also act as different button depressions or equivalent behaviors, such as the up-down and left-right movement of a joystick, for example.

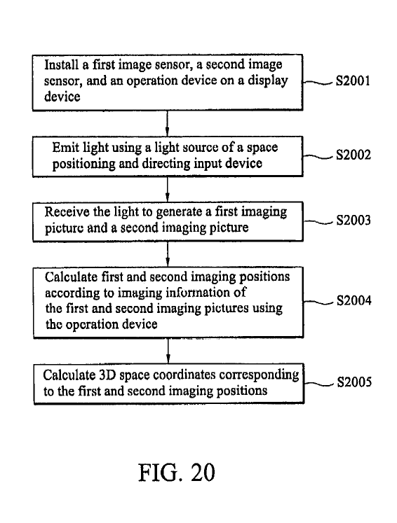

FIG. 20 is a flowchart of a processing method for the first embodiment of the space positioning and directing input system.

Referring to FIGS. 1 and 2, a first image sensor, a second image sensor, and an operation device are installed on a display device (step S2001). Light is emitted using a light source of at least one space positioning and directing input device (step S2002). The light is received to generate a first imaging picture and a second imaging picture using the first and second image sensors (step S2003). A first imaging position and a second imaging position corresponding to the light source are calculated according to imaging information of the first and second imaging pictures using the operation device (step S2004). 3D space coordinates corresponding to the first and second imaging positions are calculated (step S2005).

The space positioning and directing input device can be, but is not limited to, a joystick of a TV game or a light pen. Additionally, when only one image sensor is installed on the display device, an imaging position corresponding to the light source of the space positioning and directing input device and 2D coordinates of the imaging position corresponding to the light source are calculated using the operation device, as shown in FIGS. 7 and 8.

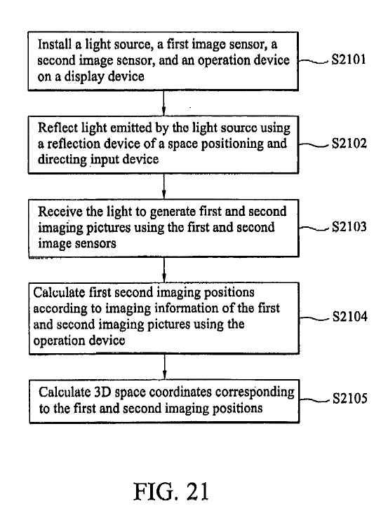

FIG. 21 is a flowchart of a processing method for the second embodiment of the space positioning and directing input system.

Referring to FIGS. 2 and 3, a light source, a first image sensor, a second image sensor, and an operation device are installed on a display device (step S2101). Light emitted by the light source is reflected using a reflection device of at least one space positioning and directing input device (step S2102). The light is received to generate a first imaging picture and a second imaging picture using the first and second image sensors (step S2103). A first imaging position and a second imaging position corresponding to the reflection device are calculated according to imaging information of the first and second imaging pictures using the operation device (step S2104). 3D space coordinates corresponding to the first and second imaging positions are calculated (step S2105).

The space positioning and directing input device can be, but is not limited to, a joystick of a TV game or a light pen. Additionally, when only one image sensor is installed on the display device, an imaging position corresponding to the reflection device and 2D coordinates of the imaging position corresponding to the reflection device are calculated using the operation device, as shown in FIGS. 8 and 9.

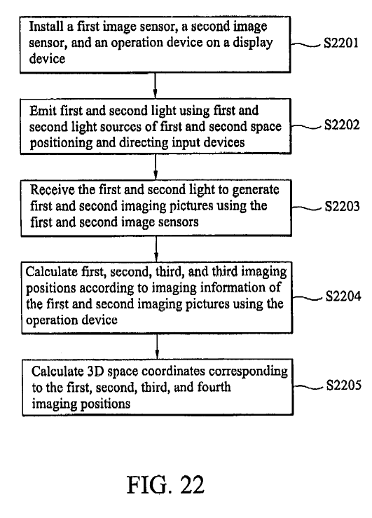

FIG. 22 is a flowchart of a processing method for the third embodiment of the space positioning and directing input system.

Referring to FIGS. 4 and 5, a first image sensor, a second image sensor, and an operation device are installed on a display device (step S2201). A first light is emitted using a first light source of a first space positioning and directing input device and a second light is emitted using a second light source of a second space positioning and directing input device (step S2202). The first and second lights are received to generate a first imaging picture and a second imaging picture using the first and second image sensors (step S2203). First and third imaging positions (p1(i1) and p1(i2)) corresponding to the first light source and second and fourth imaging positions (p2(i1) and p2(i2)) corresponding to the second light source are calculated according to imaging information of the first and second imaging pictures using the operation device (step S2204). 3D space coordinates corresponding to the first, second, third, and fourth imaging positions are calculated (step S2205).

The first and second space positioning and directing input device can be, but are not limited to, joysticks of a TV game or light pens. Additionally, when only one image sensor is installed on the display device, imaging positions corresponding to the first and second light sources of the first and second space positioning and directing input devices and 2D coordinates of the imaging positions corresponding to the first and second light sources are calculated using the operation device, as shown in FIGS. 10 and 11.

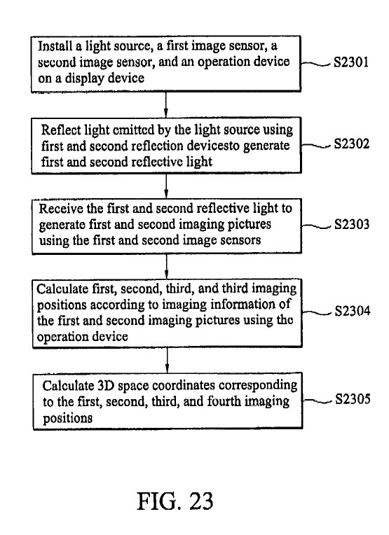

FIG. 23 is a flowchart of a processing method for the fourth embodiment of the space positioning and directing input system.

Referring to FIGS. 5 and 6, a light source, a first image sensor, a second image sensor, and an operation device are installed on a display device (step S2301). Light emitted by the light source is reflected using a first reflection device of a first space positioning and directing input device and a second reflection device of a second space positioning and directing input device to generate a first reflective light and a second reflective light (step S2302). The first and second reflective light is received to generate a first imaging picture and a second imaging picture using the first and second image sensors (step S2303). The first and third imaging positions corresponding to the first reflection device and the second and fourth imaging positions corresponding to the second reflection device are calculated according to imaging information of the first and second imaging pictures using the operation device (step S2304). 3D space coordinates corresponding to the first, second, third, and fourth imaging positions are calculated (step S2305).

The first and second space positioning and directing input device can be, but are not limited to, joysticks of a TV game or light pens. Additionally, when only one image sensor is installed on the display device, imaging positions corresponding to the first and second reflection devices and 2D coordinates of the imaging positions corresponding to the first and second reflection devices are calculated using the operation device, as shown in FIGS. 11 and 12.

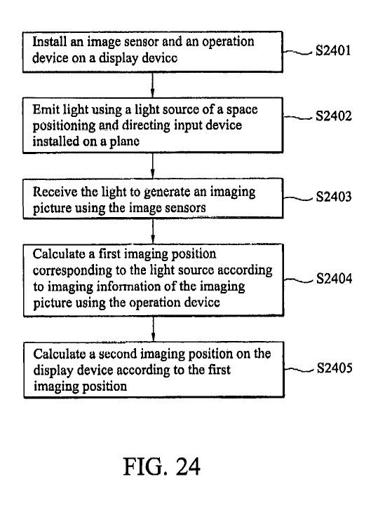

FIG. 24 is a flowchart of another processing method for the first embodiment of the space positioning and directing input system.

Referring to FIGS. 8, 13, 20, and 21, an image sensor and an operation device are installed on a display device (step S2401). Light is emitted using a light source of at least one space positioning and directing input device installed on a plane (step S2402). The light is received to generate an imaging picture using the image sensors (step S2403). A first imaging position corresponding to the light source of the space positioning and directing input device is calculated according to imaging information of the imaging picture using the operation device (step S2404). A second imaging position on the display device is calculated according to the first imaging position (step S2405).

When a first space positioning and directing input device and a second space positioning and directing input device are installed on the display device. Light is emitted using the first light source and the second light source of the first and second space positioning and directing input devices installed on the plane. The light is received to generate an imaging picture using the image sensor. A first imaging position and a second imaging position corresponding to the first and second light source are calculated according to imaging information of the imaging picture using the operation device. A third imaging position and a fourth imaging position on the display device are calculated according to the first and second imaging positions, as shown in FIGS. 11, 15, 20, and 21.

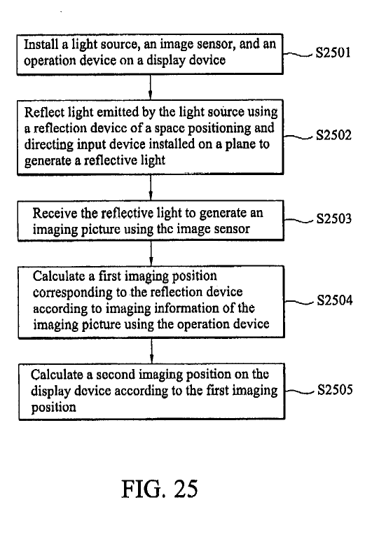

FIG. 25 is a flowchart of another processing method for the first embodiment of the space positioning and directing input system.

Referring to FIGS. 8, 14, 20, and 21, a light source, an image sensor, and an operation device are installed on a display device (step S2501). Light emitted by the light source is reflected using a reflection device of at least one space positioning and directing input device installed on a plane to generate a reflective light (step S2502). The reflective light is received to generate an imaging picture using the image sensor (step S2503). A first imaging position corresponding to the reflection device is calculated according to imaging information of the imaging picture using the operation device (step S2504). A second imaging position on the display device is calculated according to the first imaging position (step S2505).

When a first space positioning and directing input device and a second space positioning and directing input device are installed on the display device, light emitted by the light source is reflected using a first reflection device of a first space positioning and directing input device and a second reflection device of a second space positioning and directing input device installed on the display device to generate a first reflective light and a second reflective light. The first and second reflective light is received to generate an imaging picture using the image sensor. A first imaging position and a second imaging position corresponding to the first and second reflection source according to imaging information of the imaging picture and a third imaging position and a fourth imaging position on the display device according to the first and second imaging positions are calculated using the operation device, as shown in FIGS. 11, 16, 20, and 21.

It is noted that an embodiment of a space positioning and directing input system and processing method employ at least one space positioning and directing input device. However, two or more space positioning and directing input devices can also be employed. Additionally, while at least one sensor is applied to implement the invention, two or more may also be applied. The detailed process thereof has been described.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A processing method for a space positioning and directing input system, comprising:
installing a first image sensor, a second image sensor, and an operation device on a display device;
emitting light using a light source of at least one space positioning and directing input device;
receiving the light to generate a first imaging picture and a second imaging picture using the first and second image sensors;
calculating a first imaging position and a second imaging position corresponding to the light source according to imaging information of the first and second imaging pictures using the operation device; and
calculating 3D space coordinates corresponding to the first and second imaging positions.

2. The processing method for a space positioning and directing input system as claimed in claim 1, further comprising:
when only one image sensor is installed on the display device, calculating an imaging position corresponding to the light source of the space positioning and directing input device using the operation device; and
calculating 2D coordinates of the imaging position corresponding to the light source.

3. A processing method for a space positioning and directing input system, comprising:
installing a light source, a first image sensor, a second image sensor, and an operation device on a display device;
reflecting light emitted by the light source using a reflection device of at least one space positioning and directing input device;
receiving the light to generate a first imaging picture and a second imaging picture using the first and second image sensors;
calculating a first imaging position and a second imaging position corresponding to the reflection device according to imaging information of the first and second imaging pictures using the operation device; and
calculating 3D space coordinates corresponding to the first and second imaging positions.

4. The processing method for a space positioning and directing input system as claimed in claim 3, further comprising:
when only one image sensor is installed on the display device, calculating an imaging position corresponding to the reflection device using the operation device; and
calculating 2D coordinates of the imaging position corresponding to the reflection device.

5. A processing method for a space positioning and directing input system, comprising:
installing a first image sensor, a second image sensor, and an operation device on a display device;
emitting first light using first light source of a first space positioning and directing input device and second light using second light source of a second space positioning and directing input device;
receiving the first and second light to generate a first imaging picture and a second imaging picture using the first and second image sensors;
calculating first and third imaging positions corresponding to the first light source and second and fourth imaging positions corresponding to the second light source according to imaging information of the first and second imaging pictures using the operation device; and
calculating 3D space coordinates corresponding to the first, second, third, and fourth imaging positions.

6. The processing method for a space positioning and directing input system as claimed in claim 5, further comprising:
when only one image sensor is installed on the display device, calculating imaging positions corresponding to the first and second light sources of the first and second space positioning and directing input devices using the operation device; and
calculating 2D coordinates of the imaging positions corresponding to the first and second light sources.

7. A processing method for a space positioning and directing input system, comprising:
installing a light source, a first image sensor, a second image sensor, and an operation device on a display device;
reflecting light emitted by the light source to generate a first reflective light and a second reflective light using a first reflection device of a first space positioning and directing input device and a second reflection device of a second space positioning and directing input device;
receiving the first and second reflective light to generate a first imaging picture and a second imaging picture using the first and second image sensors;
calculating first and third imaging positions corresponding to the first reflection device and second and fourth imaging positions corresponding to the second reflection device according to imaging information of the first and second imaging pictures using the operation device; and
calculating 3D space coordinates corresponding to the first, second, third, and fourth imaging positions.

8. The processing method for a space positioning and directing input system as claimed in claim 7, further comprising:
when only one image sensor is installed on the display device, calculating imaging positions corresponding to the first and second reflection devices using the operation device; and
calculating 2D coordinates of the imaging positions corresponding to the first and second reflection devices.

9. A processing method for a space positioning and directing input system, comprising:
installing an image sensor and an operation device on a display device;
emitting light using a light source of at least one space positioning and directing input device installed on a plane;
receiving the light to generate an imaging picture using the image sensors;
calculating a first imaging position corresponding to the light source of the space positioning and directing input device according to imaging information of the imaging picture using the operation device; and
calculating a second imaging position on the display device according to the first imaging position.

10. The processing method for a space positioning and directing input system as claimed in claim 9, further comprising:
installing a first space positioning and directing input device and a second space positioning and directing input device on the display device;
emitting light using a first light source and a second light source of the first and second space positioning and directing input devices installed on the plane;
receiving the light to generate an imaging picture using the image sensor;
calculating a first imaging position and a second imaging position corresponding to the first and second light source according to imaging information of the imaging picture using the operation device; and
calculating a third imaging position and a fourth imaging position on the display device according to the first and second imaging positions.

11. A processing method for a space positioning and directing input system, comprising:
installing a light source, an image sensor, and an operation device on a display device;
reflecting light emitted by the light source to generate a reflective light using a reflection device of at least one space positioning and directing input device installed on a plane;
receiving the reflective light to generate an imaging picture using the image sensor;
calculating a first imaging position corresponding to the reflection device according to imaging information of the imaging picture using the operation device; and
calculating a second imaging position on the display device according to the first imaging position.

12. The processing method for a space positioning and directing input system as claimed in claim 11, further comprising:
installing a first space positioning and directing input device and a second space positioning and directing input device on the display device;
reflecting light emitted by the light source to generate a first reflective light and a second reflective light using a first reflection device of a first space positioning and directing input device and a second reflection device of a second space positioning and directing input device installed on the display device;
receiving the first and second reflective light to generate an imaging picture using the image sensor;
calculating a first imaging position and a second imaging position corresponding to the first and second reflection source according to imaging information of the imaging picture using the operation device; and
calculating a third imaging position and a fourth imaging position on the display device according to the first and second imaging positions.

13. A space positioning and directing input system, comprising:
at least one space positioning and directing input device, comprising a light source to emit light; and
a display device, further comprising:
a first image sensor, receiving the light to generate a first imaging picture;
a second image sensor, receiving the light to generate a second imaging picture; and
an operation device, calculating a first imaging position and a second imaging position corresponding to the light source according to imaging information of the first and second imaging pictures and calculating 3D space coordinates corresponding to the first and second imaging positions.

14. The space positioning and directing input system as claimed in claim 14, wherein, when only one image sensor is installed on the display device, the operation device calculates an imaging position corresponding to the light source of the space positioning and directing input device, and calculates 2D coordinates of the imaging position corresponding to the light source.

15. A space positioning and directing input system, comprising:
at least one space positioning and directing input device, comprising a reflection device to reflect light; and
a display device, further comprising:
a light source, emitting light;
a first image sensor, receiving the light of the reflection device to generate a first imaging picture;
a second image sensor, receiving the light of the reflection device to generate a second imaging picture; and
an operation device, calculating a first imaging position and a second imaging position corresponding to the reflection device according to imaging information of the first and second imaging pictures and calculating 3D space coordinates corresponding to the first and second imaging positions.

16. The space positioning and directing input system as claimed in claim 15, wherein, when only one image sensor is installed on the display device, the operation device calculates an imaging position corresponding to the reflection device, and calculates 2D coordinates of the imaging position corresponding to the reflection device.

17. A space positioning and directing input system, comprising:
a first space positioning and directing input device, comprising a light source to emit first light;
a second space positioning and directing input device, comprising a light source to emit second light; and
a display device, further comprising:
a first image sensor, receiving the first light to generate a first imaging picture;
a second image sensor, receiving the second light to generate a second imaging picture; and
an operation device, calculating first and third imaging positions corresponding to the first light source and second and fourth imaging positions corresponding to the second light source according to imaging information of the first and second imaging pictures and calculating 3D space coordinates corresponding to the first, second, third, and fourth imaging positions.

18. The space positioning and directing input system as claimed in claim 17, wherein, when only one image sensor is installed on the display device, the operation device calculates imaging positions corresponding to the first and second light sources of the first and second space positioning and directing input devices, and calculates 2D coordinates of the imaging positions corresponding to the first and second light sources.

19. A space positioning and directing input system, comprising:
a first space positioning and directing input device, comprising a first reflection device reflect light to generate a first reflective light;
a second space positioning and directing input device, comprising a second reflection device reflect light to generate a second reflective light; and
a display device, further comprising:
a light source, emitting light;
a first image sensor, receiving the first and second reflective light to generate a first imaging picture;
a second image sensor, receiving the first and second reflective light to generate a second imaging picture; and
an operation device, calculating first and third imaging positions corresponding to the first reflection device and second and fourth imaging positions corresponding to the second reflection device according to imaging information of the first and second imaging pictures and calculating 3D space coordinates corresponding to the first, second, third, and fourth imaging positions.

20. The space positioning and directing input system as claimed in claim 19, wherein, when only one image sensor is installed on the display device, the operation device calculates imaging positions corresponding to the first and second reflection devices, and calculates 2D coordinates of the imaging positions corresponding to the first and second reflection devices.

21. A space positioning and directing input system, comprising:
at least one space positioning and directing input device installed on a plane, comprising a light source emitting light; and
a display device, further comprising:
an image sensor, receiving the light to generate an imaging picture;
an operation device, calculating a first imaging position corresponding to the light source of the space positioning and directing input device according to imaging information of the imaging picture, and calculating a second imaging position on the display device according to the first imaging position.

22. The space positioning and directing input system as claimed in claim 21, wherein the display device further comprises a first space positioning and directing input device and a second space positioning and directing input device installed on the plane, first light source and second light source of the first and second space positioning and directing input devices emit light, the image sensor receives the light to generate an imaging picture, and the operation device calculates a first imaging position and a second imaging position corresponding to the first and second light sources according to imaging information of the imaging picture and calculates a third imaging position and a fourth imaging position on the display device according to the first and second imaging positions.

23. A space positioning and directing input system, comprising:
at least one space positioning and directing input device installed on a plane, comprising a reflection device reflecting light to generate a reflective light; and
a display device, further comprising:
a light source, emitting light;
an image sensor, receiving the reflective light to generate an imaging picture; and
an operation device, calculating a first imaging position corresponding to the reflection device according to imaging information of the imaging picture and calculating a second imaging position on the display device according to the first imaging position.

24. The space positioning and directing input system as claimed in claim 23, wherein the display device further comprises a first space positioning and directing input device and a second space positioning and directing input device installed on the plane, a first reflection device and a second reflection device of the first and second space positioning and directing input devices reflect light emitted by the light source to generate a first reflective light and a second reflective light, the image sensor receives the first and second reflective light to generate an imaging picture, and the operation device calculates a first imaging position and a second imaging position corresponding to the first and second reflection devices according to imaging information of the imaging picture and calculates a third imaging position and a fourth imaging position on the display device according to the first and second imaging positions.
